(19) United States
(12) Patent Application Publication
(10) Pub. No.: US 2004/0069702 A1
(43) Pub. Date: Apr. 15, 2004

(54) Filter element

(76) Inventors: Bjarne Ekberg, Turku (FI); Olli Hognabba, Kantvik (FI)

Correspondence Address: Morgan & Finnegan, 1775 Eye Street, Suite 400, Washington, DC, 20006, US

(21) Appl. No.: 10/433,804

(22) PCT Filed: Dec. 7, 2001
(86) PCT No.: PCT/FI01/01063

(51) Int. Cl. B01D 33/23

(52) U.S. Cl. 210/347; 210/486

(57) ABSTRACT

The invention relates to a filter element for removing moisture contained in a material to be dried and for creating a filter cake of the material to be dried on the filtering surface of the filter element. According to the invention, the filtering surface (1. 6) the filter element (11) is composed of at least two parts (2,3;7,8) where mutually different filtering conditions can be created in order to form a filter cake containing at least one component to be filtered on the whole filtering surface (1,6) of the filter element (11).

The present invention relates to a filter element that is suited for removing liquids contained in a material to be dried in a suction drier, so that on the filtering surface of the filter element, the material to be dried is formed into a filter cake that is essentially homogeneous in quality.

From the U.S. Pat. No. 4,981,589 there is known a two-piece filter structure made of a ceramic material, where the surface layer and the first layer in the proceeding direction of the filtered liquid serve as the filtering layer proper. Said filtering layer is fixed to an inner layer that is remarkably thicker than the surface layer and serves as a support layer.

From the U.S. Pat. No. 4,863,656 there is known a filter plate comprising a space provided between the filtering surfaces, which space is filled with a granular material. In said plate, the liquid to be removed from the target to be dried flows through the filtering surfaces, into the space provided therebetween and further out of the filter plate.

Filter plates according to the U.S. Pat. Nos. 4,863,656 and 4,981,589 are used for instance in a suction drier where the filter plates are installed in a rotary housing of the suction drier. Further, the filter plates are arranged to be shifted to be in contact with the material to be dried, located in the filtering tank, so that the filter plate is immersed in the material to be dried, in which case the liquid is sucked out of the material to be dried through the suction surfaces provided in the filter plates. Owing to the effect of underpressure, the material to be dried is attached to the filter plate surface during the suction step. While the filter plates are attached to the rotary housing of the suction drier, the filter plates are usually designed so that they grow wider in the radial direction, when proceeding towards the outer circumference of the disc formed by the filter plates. Now the material to be dried resides for a longer time on the outer circumference of the filter plate than on the inner circumference. However, because the suction penetrating the whole filter plate is maintained throughout the process of forming the filter cake, the cake near the outer circumference becomes thicker than near the inner circumference of the filter plate. This kind of variation in the filter cake thickness results in difficulties in the further steps of the filtering process. Moreover, the density and particle size of the material to be dried usually fluctuate, so that in the surface sections of the material to be dried, the density and the particle size are smaller than elsewhere in the material. These matters also affect the characteristics of the filter cake created on the filter plate, so that the part of the filter cake that is placed on the inner circumference of the filter plate has different characteristics than the part placed on the outer circumference.

The object of the invention is to eliminate the drawbacks of the prior art and to achieve an improved filter element, where the structure of the employed suction drier and the characteristics of the material to be dried are taken into account, so that there is realized an improved filter cake on the filtering surface of the filter element for further processing. The essential novel features of the invention are apparent from the appended claims.

According to the invention, the filtering surface of the filter element suited in a suction drier is formed of at least two parts where mutually different filtering conditions can be created in order to form a filter cake containing at least one component to be filtered on the filtering surface of the whole filter element. In order to support the filtering surface formed of the different parts of the filter element, inside the filter element there is to be formed a support layer on which the filtering surface of the filter element is installed. The filter element can be installed in the suction drier housing also without the support layer created inside the filter element. Moreover, inside the filter element there are provided members in order to transfer the liquid removed from the material to be dried out of the filter element, as well as members for fastening the filter element onto the suction drier housing.

The filtering surface of the filter element according to the invention can be installed on one or two sides of the fastening point between the filter element and the suction drier. When the filtering surface is installed only on one side of the fastening point between the filter element and the suction drier, the filtering surface is formed of at least two mutually adjacent elements where different filtering conditions can be created. When the filtering surface is installed on both sides of the fastening point between the filter element and the suction drier, the filtering surface is thus formed of at least two mutually opposite elements which as such further can be formed of at least two adjacent parts of a filtering surface or which as such have different filtering conditions with respect to each other.

The parts of the filtering surface of the filter element according to the invention are made of one or several different materials. Advantageously the material of the filtering surface of the filter element is a ceramic, porous material, but it can also be metal, such as nickel, or some carbon-bearing material. When the filtering surface of the filter element is made of one material only, different filtering properties are obtained for the various parts of the filtering surface for instance by adjusting the permeability of said parts. When the filtering surface of the filter element is made of several different materials, said materials are arranged in the filtering surface so that apart from the properties of the filter cake to be formed, there also are taken into account possible corrosion effects.

When using a filter element according to the invention, the filtering surface can advantageously be made such that by utilizing the properties of the material or materials constituting the filtering surface for instance the filter cake to be created on the filtering surface installed on the rotary housing of the suction drier is made essentially homogeneous in quality irrespective of the time that the filtering surface stays in contact with the material to be dried. When this kind of filter element is rotated around the axis of the suction drier housing, that part of the filtering surface of the filter element that is placed furthest from the housing stays in contact with the material to be dried for a longer time than that part that is nearer to the suction drier housing. Now in that part of the filtering surface that stays in contact with the material to be dried for a shorter period there is installed material with a higher permeability than in that part that stays in contact with the material to be dried for a longer period. Thus the created filter cake becomes drier than with the filter plate of the prior art, because a filter cake created on the filtering surface is always moister when it is thicker.

When employing the filter element according to the invention, it is also possible to filter simultaneously two or several components of the material to be dried, so that the properties of said components can be essentially different. In order to filter different components, the parts of the filtering surface of the filter element are made of materials with for example different permeability, so that with different permeability, there are obtained filter cakes with a different degree of moisture. In order to filter different components, the elements of the filtering surface of the filter element can also have different electric properties.

The invention is explained in more detail below, with reference to the appended drawings, where

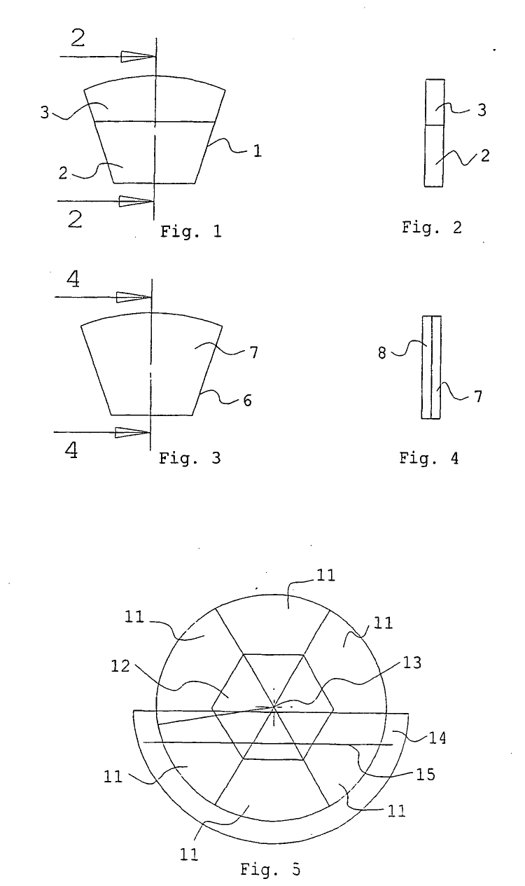

FIG. 1 shows a preferred embodiment of the invention in a side-view illustration,

FIG. 2 illustrates the embodiment of FIG. 1, seen in the direction 2-2,

FIG. 3 shows another preferred embodiment of the invention in a side-view illustration,

FIG. 4 shows the embodiment of FIG. 3, seen in the direction 4-4, and

FIG. 5 shows the embodiment of FIG. 1 in a side-view illustration, as installed in a suction drier known as such.

According to FIGS. 1 and 2, the filtering surface 1 of the filter element according to the invention consists of two adjacently arranged parts 2 and 3, so that the permeability of the part 2 is higher than that of part 3.

In the embodiment according to FIGS. 3 and 4, the filtering surface 6 of the filter element according to the invention consists of two parts 7 and 8 arranged opposite to each other. On the basis of the electric properties of said parts 7 and 8, on the surfaces of the parts 7 and 8 there can be created filter cakes containing different components of the material to be filtered.

In FIG. 5, the filter element 11 according to the invention is installed in the rotary housing 12 of the suction drier. The housing 12 of the suction drier is arranged to rotate around the axis 13. The housing 12 of the suction drier is further installed, with respect to the settling tank 14, so that when the housing 12 rotates around the axis 13, the filter element 11 is at least partly brought underneath the surface of the slurry 15 contained in the settling tank 14. When the housing 12 rotates around its axis 13, the part 3 of the filtering surface 1 of the filter element 11 stays under the surface of the slurry 15 for a longer period than the part 2 of the filtering surface 1 of the filter element. Because the permeability of the part 2 of the filtering surface 1 is better than that of the part 3 of the filtering surface 1, a filter cake with an essentially homogeneous thickness is obtained on the part 2 of the filtering surface 1 in shorter time than on the part 3 of the filtering surface 1. Consequently, a filter cake that is essentially homogeneous in quality is created on the parts 2 and 3 of the filtering surface 1.

1. A filter element for removing moisture contained in a material to be dried and for creating a filter cake of the material to be dried on a filtering surface of a filter element, characterized in that the filtering surface (1,6) of the filter element (11) is composed of at least two parts (2,3;7,8), where by means of the mutual position and/or material of the parts (2,3;7,8) of the filtering surface (1,6) mutually different filtering conditions can be created in order to form a filter cake containing at least one component to be filtered on the whole filtering surface (1,6) of the filter element (11).

2. A filter element according to claim 1, characterized in that the parts (2,3) of the filtering surface (1) of the filter element (11) are installed adjacently with respect to each other.

3. A filter element according to claim 1, characterized in that the parts of the filtering surface (6) of the filter element are positioned opposite to each other (7,8).

4. A filter element according to any of the preceding claims, characterized in that the parts (2,3;7,8) of the filtering surface (1,6) of the filter element (11) are different in permeability.

5. A filter element according to any of the preceding claims 1-3, characterized in that the parts (2,3;7,8) of the filtering surface (1,6) of the filter element (11) are different in their electric properties.

6. A filter element according to any of the preceding claims 1-3, characterized in that parts (2,3;7,8) of the filtering surface (1,6) of the filter element (11) are different in material.

7. A filter element according to any of the preceding claims 1-3, charact rized in that the parts (2,3;7,8) of the filtering surface (1,6) of the filter element (11) are made of the same material in order to create the filter cake.

8. A filter element according to any of the preceding claims 1-6, characterized in that the different parts (2,3;7,8) of the filtering surface (1,6) of the filter element (11) are for creating filter cakes of different components of the filtering material.
